(19) United States
(12) Patent Application Publication
(10) Pub. No.: US 2014/0321150 A1
(43) Pub. Date: Oct. 30, 2014

(54) Decorative Lighting Device For Skateboards

(71) Applicant: SANDIFORD ENTERPRISES, LLC, Atlantic Beach, FL (US)

(72) Inventor: Chad P. Sandiford, Atlantic Beach, FL (US)

(73) Assignee: SANDIFORD ENTERPRISES, LLC, Atlantic Beach, FL (US)

(21) Appl. No.: 13/869,125

(22) Filed: Apr. 24, 2013

(51) Int. Cl. F21S 8/10; A63C 17/00

(52) U.S. Cl. CPC F21S 48/30; A63C 17/0013
USPC 362/545; 362/546

(57) ABSTRACT

Decorative skateboard lighting devices are disclosed. In an aspect, a light device comprising a light source, a housing, a power source, and a microcontroller is disclosed, configured to removably attached to an underside of a skateboard deck and provide a decorative lighting effect. The housing is configured to contain the power source and the microcontroller and removably attach to a skateboard via a set of connector bolts configured to mount a truck to the skateboard deck. The housing is configured to be positioned along a longitudinal center plane of the deck and adjacent to the truck. In an aspect, lighting device is controlled via a remote control. In another aspect, the lighting device is configured to cause the light source to perform various lighting functions such as glowing, flashing, strobing, and the like.

### FIELD OF THE DISCLOSURE

The present disclosure relates to skateboard accessories, and more particularly to decorative lighting devices for skateboards.

### BACKGROUND

Skateboarding is an extremely popular recreational activity among many age groups. Skateboards are customized by adding, among other things, stickers, grip tape, specialized trucks, and unique wheels These and other customizations have grown in popularity. Skateboarders are constantly on the lookout for new and distinctive accessories to add to their skateboards. Lighted skateboard decks and lighting kits are among the accessories that have emerged for skateboards. Despite the success of lighting kits for other wheeled vehicles, like automobile underglow kits, skateboard lighting accessories have not been widely adopted because of deficiencies in prior designs.

Existing lighted skateboards typically comprise a skateboard deck having one or more grooves, holes, or other voids machined into the surface of the deck. Often, the voids are positioned around the perimeter of the deck. One or more lights (e.g., an LED bulb) are screwed into the voids, creating a string of lights around the deck. Such lighted decks also typically include a power source and microcontroller which respectively power and control the light string. The power source and microcontroller may be contained in a housing attached to the underside of the deck via screws. In other designs, the housing is inserted into a hole cut into the middle portion of the deck.

Such lighted skateboards must be custom designed and bunt, driving up the cost of such designs, limiting their availability, and reducing a skateboarder's ability to truly customize their skateboard. Such designs require significant removal of deck material and insertion of multiple screws into the deck which may weaken the deck, causing it to break under what would be considered “normal” use conditions. Therefore, such designs have piqued the interest of skateboarders, but have not found widespread acceptance.

Also available are skateboard lighting kits are that generally include a light source attached via a fastener, an adhesive, or Velcro®, fasteners (available from Velcro USA, Inc. of Manchester, N.H.) and a housing containing a power source and a microcontroller. Such kits are configured to create a decorative lighting effect for a skateboard comprising a deck and two trucks. The trucks attach to the underside of the deck via bolts. The housing may be attached to the skateboard by placing it between the deck and a truck, thereby increasing the distance between the deck and the truck and altering the performance characteristics of the skateboard.

In the alternative, the housing may attach to the skateboard via a mounting plate placed between the deck and the truck, thereby avoiding increasing the distance between the deck and the truck. The housing is attached to an outboard side of the mounting plate and is significantly thicker than the mounting plate. This positioning impedes the ability of the deck to pivot relative to the truck because the housing will collide with the truck or an attached wheel. Such collisions negatively affect the turning ability of the skateboard.

Given the foregoing, what is needed are devices which provide decorative lighting for skateboards wherein the device may be installed on the skateboard by a skateboarder without requiring drilling or other significant alteration of the skateboard, Additionally, devices having a small footprint are needed in order to provide decorative lighting without significantly altering the skateboard's performance. Devices are also needed which removably attach a light source, a power source, and a microcontroller to the skateboard without altering the turning performance, deck height, or other performance characteristics of the skateboard.

### SUMMARY

This Summary is provided to introduce a selection of concepts in a simplified form that are further described below in the Detailed Description. This Summary is not intended to identify key features or essential features of the subject matter to be claimed, nor is it intended to be used to limit the scope of the subject matter to be claimed.

The present disclosure is directed to decorative skateboard lighting devices and other like recreational devices (e.g., scooters, casterboards, devices comprising a deck and one or more attached trucks, Ripstik boards, or the like) which may be installed on a skateboard without altering a deck of the skateboard, using existing connector bolts for the trucks. Devices in accordance with the present disclosure are adapted for use with a skateboard comprising a deck and two trucks having a plurality of wheels. The trucks attach to an underside of the deck and are configured to pivot relative to the deck, causing the skateboard to turn. Such devices provide decorative lighting for skateboards without impeding the turning ability of the skateboard or significantly increasing the distance between the deck and a truck.

In some aspects of the present disclosure, a lighting device comprises a light source, a power source, and a microcontroller.

The microcontroller and the power source are contained in a housing. The housing is configured to provide protection from impacts and other environmental hazards and to mount to the underside of a deck. The housing comprises an extension, the extension being a thin, rigid member designed to mount in between the deck and a truck via insertion of skateboard connector bolts, thereby securing the housing to the skateboard. A portion of the housing containing the power source and the microcontroller is positioned along a centerline of the skateboard such that turning operation of the skateboard is not impeded. In some aspects of the present disclosure, attachment of the housing to the skateboard deck may be reinforced by interconnecting the deck and the housing using adhesive, Velcro fastener, a removable fastener, or the like.

In some aspects, the light source may be a strip of light emitting diodes (LEDs). The light source is attached to the underside of the deck using adhesive, Velcro fastener, a removable fastener, or the like, in some aspects, the light strip may be attached using a permanent adhesive. The light source provides decorative underbody lighting for the skateboard. Light may be emitted in one direction, creating a ray-like effect, or many different directions, creating a diffuse underglow effect. The light source is electrically connected to the power source and the microcontroller. The microcontroller may regulate the light source based on user inputs. In some aspects, the microcontroller may cause the light source to, for example, glow, flash, twinkle, strobe, alternate between functions, or the like. In some aspects the light source may emit multiple colors of light. User input may be received via one or more switches or via a remote control.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIGS. 1A & 1B are side views of a skateboard and a decorative skateboard lighting device, in accordance with an aspect of the present disclosure.

FIGS. 2A & 2B are side views of a skateboard and a decorative skateboard lighting device depicting configurations of the skateboard and the lighting device, in accordance with an aspect of the present disclosure.

FIG. 3 is a plan view of a decorative skateboard lighting device, in accordance with an aspect of the present disclosure.

FIG. 4 is a bottom view of a skateboard and a decorative skateboard lighting device, depicting a configuration of a light source, in accordance with an aspect of the present disclosure.

FIG. 5 is a bottom view of a skateboard and a decorative skateboard lighting device, depicting another configuration of a light source, in accordance with an aspect of the present disclosure.

FIG. 6 is a bottom view of a skateboard, depicting a lighting device comprising multiple light sources, in accordance with an aspect of the present disclosure.

FIG. 7 is a bottom view of a skateboard, depicting a lighting device comprising multiple light sources, in accordance with an aspect of the present disclosure.

FIG. 8 is a bottom view of a skateboard and a decorative skateboard lighting device, depicting two lighting devices attached to the skateboard, in accordance with an aspect of the present disclosure.

FIG. 9 is a side view of a skateboard and a decorative skateboard lighting device wherein the lighting device comprises a remote, in accordance with an aspect of the present disclosure.

FIG. 10 is a block diagram of an example computing system useful for implementing the present disclosure.

### DETAILED DESCRIPTION

The present disclosure is directed to decorative skateboard lighting devices and systems which may be installed on a skateboard without altering a deck of the skateboard.

Devices and systems in accordance with certain aspects of the present disclosure are adapted for use with a skateboard comprising a deck and two trucks having a plurality of wheels. The trucks attach to an underside of the deck and are configured to pivot relative to the deck, causing the skateboard to turn. Such devices provide decorative lighting for skateboards without impeding the turning ability of the skateboard or significantly increasing the distance between the deck and a truck.

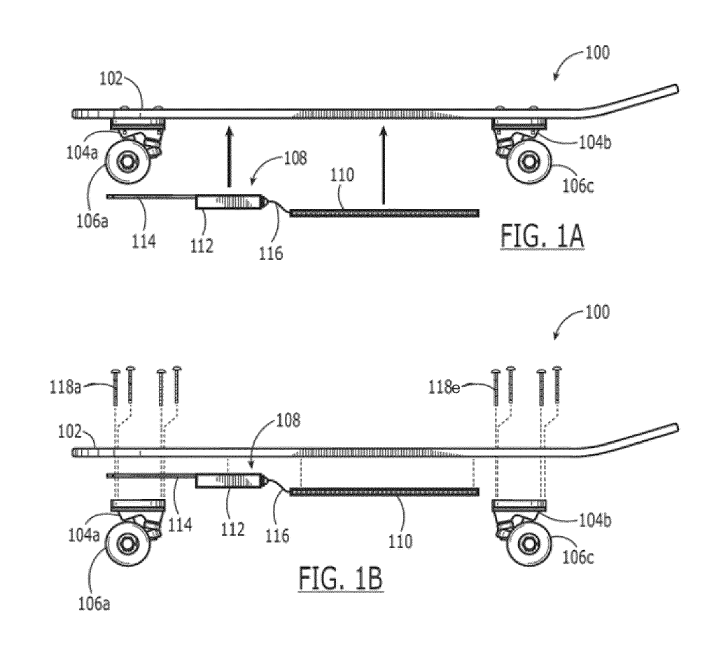

Referring now to FIGS. 1A & 1B, side views of a skateboard 100 and a decorative skateboard lighting device 108, in accordance with an aspect of the present disclosure, is shown.

Skateboard 100 comprises a deck 102 and two trucks 104 (labeled, for clarity, as trucks 104a,b in FIG. 1A). Each truck comprises two wheels (labeled, for clarity only as wheels 106a,c in FIG. 1A). Trucks 104 are pivotally attached to deck 102. Skateboard 100 may turn via tilting deck 102 along the long axis of deck 102, thereby causing a lower portion of deck 102 to come into dose proximity to wheel 106 and trucks 104 to yaw relative to deck 102.

Deck 102 comprises two sets of four channels (not shown in FIG. 1). Bolts 118 (labeled, for clarity, only as bolts 118a,e in FIG. 1B) are inserted through each channel and removably connect to truck 104. In an aspect, each truck 104 is held in place by four bolts 118. Each bolt 118 passes through deck 102, through a truck channel (not shown in FIG. 1), and is secured on a bottom portion by a fastener (not shown in FIG. 1).

Lighting device 108 comprises a light source 110 and a housing 112.

Light source 110 is configured to provide decorative lighting, thereby enhancing the overall appearance of skateboard 100. Light source 110, in one aspect of the present disclosure, may be a strip of light emitting diodes (LEDs), Alternatively, light source 110 may be an OLED strip, EL wire, one or more fluorescent bulbs, one or more incandescent bulbs or some other source of light that will be apparent to those having skill in the relevant art(s) after reading the description herein.

Light source 110 may be configured to emit light of one color or multiple colors, in an aspect, light source 110 comprises LEDs which can selectively emit any color in the visible spectrum. As detailed below, in such aspects, the skateboard user may select the color being emitted via a switch or remote. Light source 110 may be configured to emit a diffuse “pool” of light underneath skateboard 100, thereby creating an underglow effect. In another aspect, light source 110 may be configured to emit a static or moving beam of light, creating a ray-like effect.

Light source 110 may be attached to the underside of deck 102 via one or more fasteners (not shown in FIG. 1). Such fasteners may be removable or permanent. In an aspect, light source 110 is removably attached to the underside of deck 102 via a strip of Velcro fastener. Alternatively, light source 110 may be attached using permanent or removable adhesive, attached via screws, or other fasteners that will be apparent to those having reasonable skill in the art(s) after reading the description herein. In an aspect, light source 110 may be positioned longitudinally on the underside of deck 102 and between truck 104a and truck 104b and removably attached via a Velcro fastener.

Housing 112 is configured to house a power source and a microcontroller (not shown). The power source and the microcontroller facilitate operation of light source 110. In an aspect, housing 112 is a rigid separable casing designed to enclose the power source and the microcontroller. Housing 112 may be a rectangular, rigid, separable casing comprising a top housing portion and a bottom housing portion. The top housing portion is configured to contact the underside of deck 102.

Housing 112 may further comprise baseplate 114. Baseplate 114 extends from a front housing portion of housing 112 and comprises a top baseplate portion and a bottom baseplate portion. Top baseplate portion is flush with top housing portion, creating a surface which may contact the underside of deck 102. As shown in FIG. 3, baseplate 114 further comprises forward channels 306 (labeled as forward channels 306a,b in FIG. 3) and rear channels 308 (labeled as rear channels 308a,b in FIG. 3). Forward channels 306 and rear channels 308 are openings positioned on baseplate 114 to allow bolts 118 to pass through baseplate 114 when bolts 118 are inserted into deck 102, as shown in FIG. 1B. Bolts 118 may be connectors traditionally used in skateboards 100 to connect truck 104 to deck. Utilization of bolts 118 in this manner enables the connection of lighting device 108 to skateboard without drilling additional holes in deck 102. In an aspect, forward channel 306 and rear channel 308 are circular openings, having a diameter approximately equal to the diameter of the deck channels. In another aspect, forward channel 306 or rear channel 308 may be an elongated opening configured to receive bolts 118 in a variety of patterns and spacings.

Housing 112 attaches to skateboard 100 above truck 104 via the insertion of a set of four bolts 118 through corresponding forward channels 306 and rear channels 308.

Skateboards 100 may optionally comprise riser pads placed between deck 102 and truck 104, similar to the location of baseplate 114. The thickness of baseplate 114 is minimized in order to avoid alteration of the performance and other characteristics of skateboard 100. In an aspect, baseplate 114 thickness is approximately equal to the thickness of a riser pad.

Where one lighting device 108 is used with skateboard 100, baseplate 114 may be attached to truck 104a Truck 104b may attach to deck with the addition of a riser pad having a thickness approximately equal to the thickness of baseplate 114, thereby avoiding alteration of skateboard 100 performance and other characteristics compared to the same board comprising two riser pads and no lighting devices 108.

Light source 110 is electrically connected to the power source and microcontroller contained in housing 112 via conduit 116, thereby enabling control of light source 110. In an aspect, the power source is a rechargeable battery such as a lithium polymer battery, a lithium on battery, a nickel cadmium battery, or the like. In another aspect, the power source is one or more removable, standard format batteries such as AA or AAA batteries. The power source may comprise recharging elements (e.g., photovoltaic cells) or connectors (e.g., a female 12 volt plug connector),

The microcontroller regulates the power sent from the power source to light source 110. Regulation may be done based on user input (e.g., user activation of an on/off switch) or based on preprograms instructions contained within the microcontroller (e.g., flashing commands).

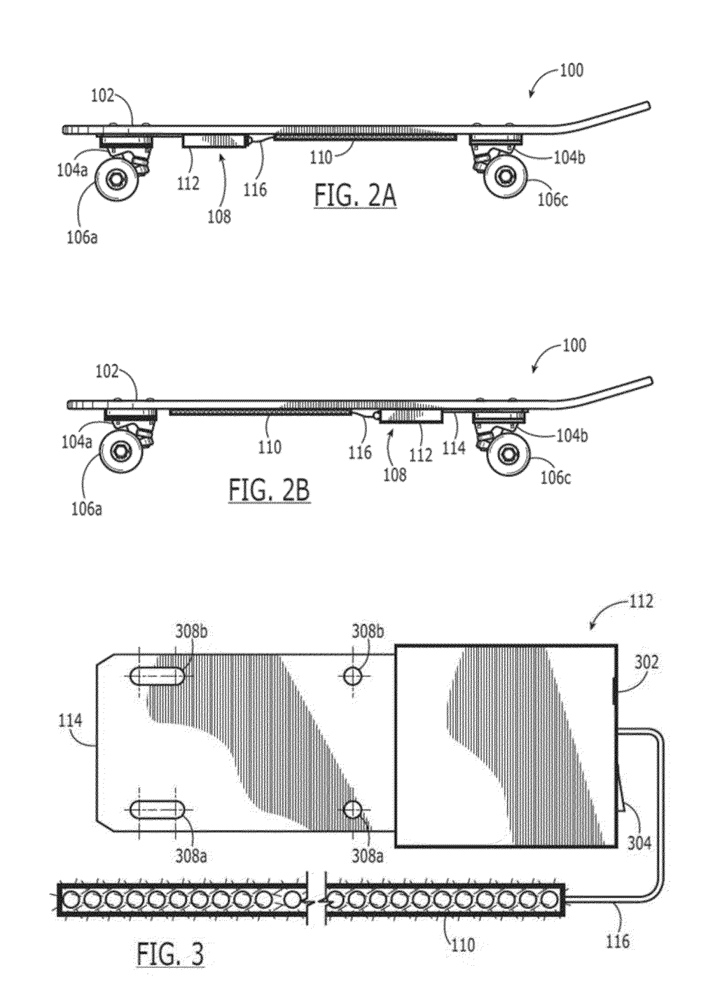

Referring now to FIGS. 2A & 2B, side views of skateboard 100 and decorative skateboard lighting device 108 depicting configurations of skateboard 100 and lighting device 108, in accordance with various aspects of the present disclosure, are shown. Baseplate 114 may be configured to connect lighting device 108 to skateboard at a front truck 104a or a rear truck 104b.

Referring now to FIG. 3, a plan view of decorative skateboard lighting device 108, in accordance with an aspect of the present disclosure, is shown.

Housing 112 may further comprise indicator 302 and switch 304. Switch 304 may be actuated by a user in order to activate and deactivate lighting device 108. Switch 304 may be a toggle switch, a push button, a three way switch, or the like.

Indicator 302 may be a light configured to be active when lighting device 108 is turned on. In another aspect, indicator 302 may be configured to indicate other conditions of lighting device 108, such as a low battery condition or connectivity with a remote 902 (shown in FIG. 9).

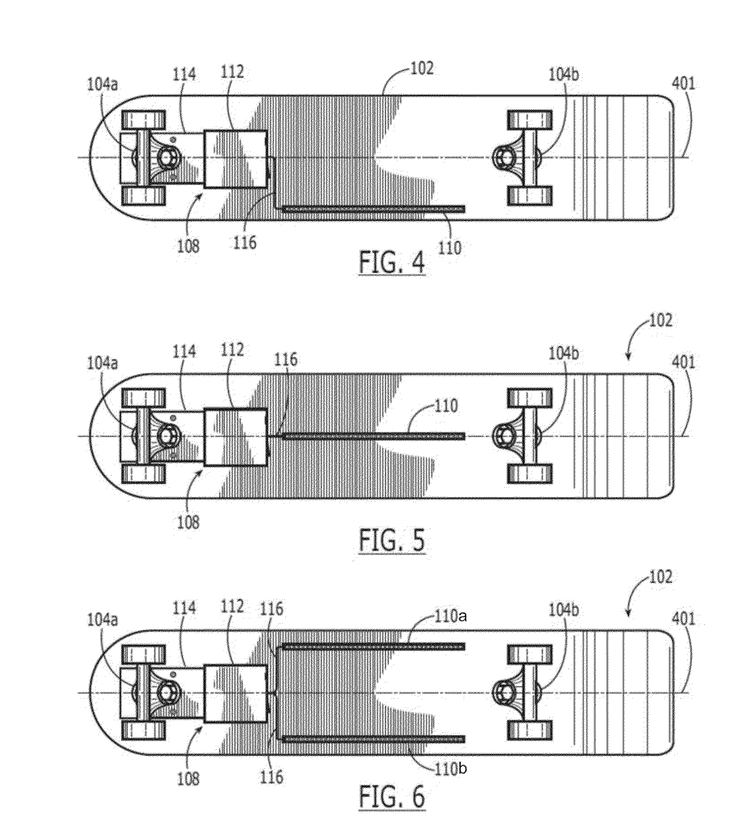

Referring now to FIG. 4, a bottom view of skateboard 100 and decorative skateboard lighting device 108, depicting a configuration of skateboard 100 and light source 110, in accordance with an aspect of the present disclosure, is shown. Centerline 401 indicates the long axis of skateboard 100. Lighting device 108 is configured such that housing 112 is placed along centerline 401, thereby connecting lighting device 108 to skateboard 100 without impeding movement of truck 104. Housing 112 may be placed in front of truck 104 or behind truck 104 while avoiding interference with normal truck 104 operation.

Referring now to FIG. 5, a bottom view of skateboard 100 and decorative skateboard lighting device 108, depicting another configuration light source 110, in accordance with an aspect of the present disclosure, is shown.

As shown, light source 110 may be attached to a variety of portions of deck 102. Light source 110 may be centered on the underside of deck 102, attached in an offset position (as shown in, for example, FIG. 4), attached to a top portion of deck 102 (not shown), or attached to another portion of skateboard 100 as will be apparent to those skilled in the relevant art(s) after reading the description herein.

Referring now to FIGS. 6 and 7, bottom views of skateboard 100, depicting lighting device 108 comprising multiple light sources 110 (labeled, for clarity, as light source 110a, b in FIG. 6 and light source 110a-c in FIG. 7), in accordance with an aspect of the present disclosure, are shown.

Lighting device 108 may comprise multiple light sources 110, each attached to deck 102 via fasteners such as adhesive.

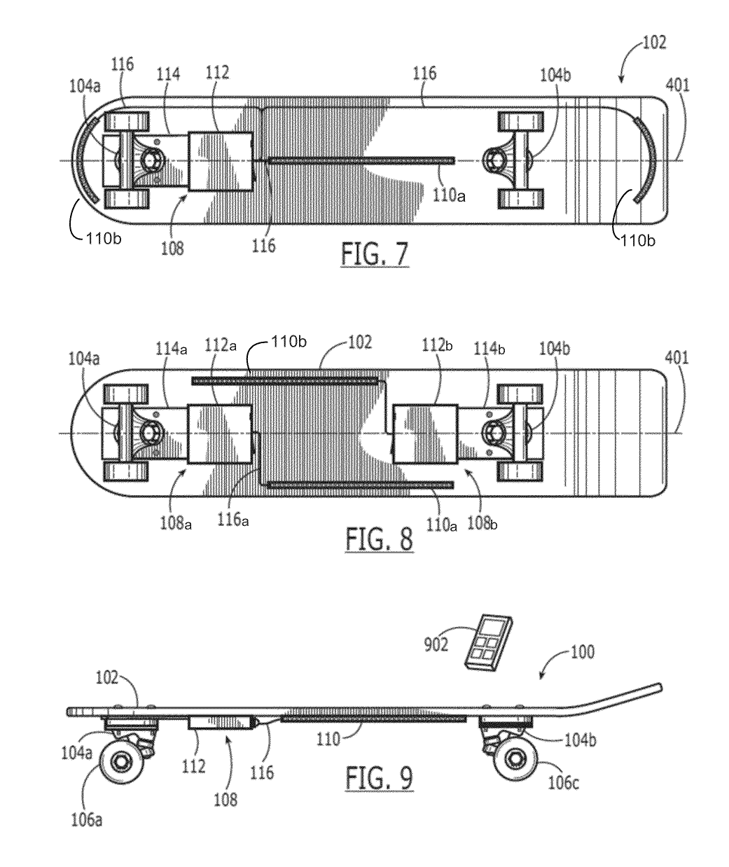

Referring now to FIG. 8, a bottom view of skateboard 100, depicting two lighting devices 108 attached to skateboard 100, in accordance with an aspect of the present disclosure, is shown.

One lighting device may be attached at truck 104a, placing housing 112a behind truck 104a. A second lighting device may be attached at truck 104b, placing housing 112b in front of truck 104b. In this manner, more power may be provided to light source 110 and independent control of light source 110 may be facilitated.

Referring now to FIG. 9, a side view of skateboard 100 and decorative skateboard lighting device 108 wherein lighting device 108 comprises a remote 902, in accordance with an aspect of the present disclosure, is shown.

Lighting device 108 may be controlled via user input. User input may be received via switch 304 or remote 902. Remote 902 may communicate with the microcontroller via wireless means such as acoustic, RF Bluetooth, telephony, infrared, and other wireless means. In another aspect, remote 902 may communicate with the microcontroller via wired connection.

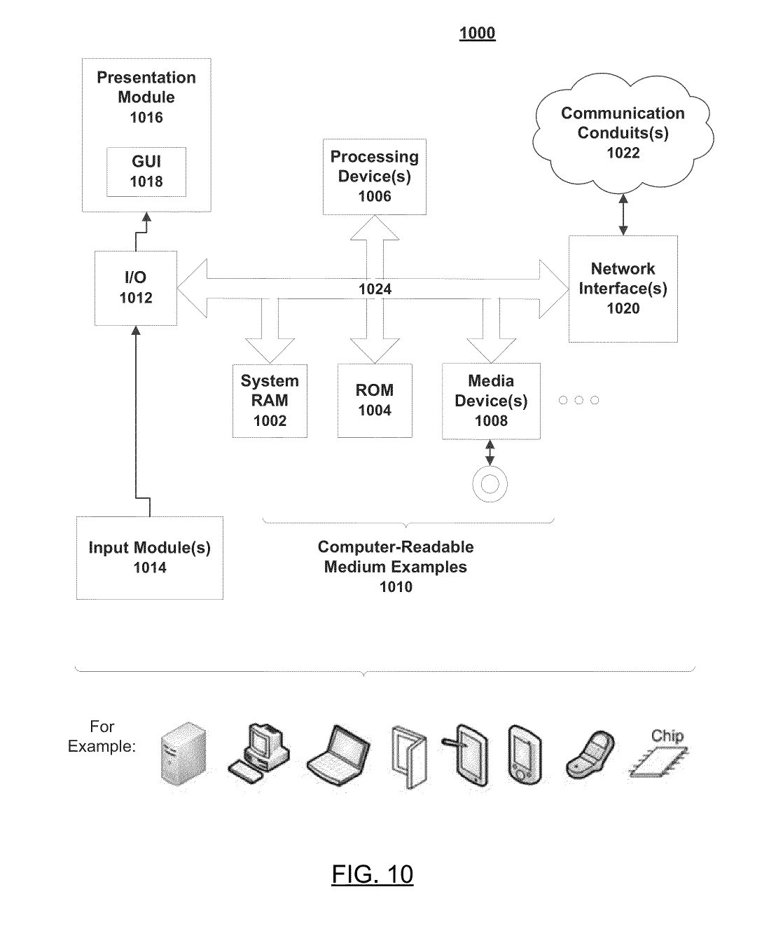

Referring now to FIG. 10, a block diagram of an exemplary computer system useful for implementing various aspects of the present disclosure, is shown. That is, FIG. 10 sets forth illustrative computing functionality 1000 that may be used to control one or more light sources 110 in response to input received from switch 304, remote 902, or from programs contained within the microcontroller, in all cases, computing functionality 1000 represents one or more physical and tangible processing mechanisms.

Computing functionality 1000 may comprise volatile and non-volatile memory, such as RAM 1002 and ROM 1004, as well as one or more processing devices 1006 (e.g., one or more central processing units (CPUs), one or more graphical processing units (GPUs), and the like). Computing functionality 1000 also optionally comprises various media devices 1008, such as a hard disk module, an optical disk module, and so forth. Computing functionality 1000 may perform various operations identified above when the processing device(s) 1006 executes instructions that are maintained by memory (e.g., RAM 1002, ROM 1004, and the like).

More generally, instructions and other information may be stored on any computer readable medium 1010, including, but not limited to, static memory storage devices, magnetic storage devices, and optical storage devices. The term “computer readable medium” also encompasses plural storage devices. In all cases, computer readable medium 1010 represents some form of physical and tangible entity. By way of example, and not limitation, computer readable. medium 1010 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 1002, ROM 1004, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 1000 may also comprise an input/output module 1012 for receiving various inputs (via input modules 1014), and for providing various outputs (via one or more output modules). One particular output mechanism may be a presentation module 1016 and an associated GUI 1018. Computing functionality 1000 may also include one or more network interfaces 1020 for exchanging data with other devices via one or more communication conduits 1022. In some aspects, one or more communication buses 1024 communicatively couple the above-described components together.

Communication conduit(s) 1022 may be implemented in any manner (e.g., by a local area network, a wide area network (e.g., the Internet), and the like, or any combination thereof). Communication conduit(s) 1022 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 10. The features of the present disclosure described herein are platform-independent, meaning that the techniques can be implemented on a variety of commercial computing platforms having a variety of processors.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., on a scooter, a casterboard, a device comprising a deck and one or more attached trucks, a Ripstik® board available from Razor USA, LLC of Cerritos, Calif., a Freebord board available from Freebord Manufacturing, LLC of San Francisco, Calif., or the like). As will be appreciated by those skilled in the relevant art(s) after reading the description herein, certain features from different aspects of the devices and systems of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A decorative skateboard lighting device configured to be removably connected to a skateboard comprising a deck, a first truck, a second truck, a first set of connector bolts, and a second set of connector bolts, the lighting device comprising:
a light source attachable to an underside of the deck via a light source fastener;
a housing configured to removably mount to the underside of the deck, comprising:
a front housing portion;
a rear housing portion;
a top housing portion; and
a bottom housing portion;
wherein the top housing portion and the bottom housing portion being spaced, generally parallel, and connected by the front housing portion and the rear housing portion, defining a cavity containing a power source and a microcontroller; and
wherein the front housing portion further comprising a baseplate extending outward from the front housing portion;
wherein the baseplate adapted to be removably connected the housing to the skateboard via insertion of one of: at least one of the first set of connector bolts; and at least one of the second set of connector bolts; through the baseplate;
wherein the housing configured to interface with the underside of the deck at the top housing portion;
wherein the housing, when removably connected to the skateboard, positioned along a longitudinal center plane of the deck and adjacent to one of: a first truck and a second truck; and
wherein the power source is controlled by the microcontroller and the power source is electrically connected to the light source.

2. The lighting device of claim 1, wherein the baseplate is a rigid member comprising:
at least one forward channel;
at least one rear channel;
a top baseplate portion; and
a bottom baseplate portion;
wherein the at least one forward channel and the at least one rear channel is configured to receive one of: at least one of the first set of connector bolts and at least one of the second set of connector bolts; and
wherein the top baseplate portion and the bottom baseplate portion are spaced a baseplate thickness apart and generally parallel.

3. The lighting device of claim 2, wherein the top housing portion and the bottom housing portion are separated by a housing thickness and the baseplate thickness is less than a quarter of the housing thickness.

4. The lighting device of claim 2, wherein the baseplate thickness is between one and five millimeters.

5. The lighting device of claim 2, wherein the top baseplate portion and the top housing portion form a smooth surface configured to contact the underside of the deck.

6. The lighting device of claim 1, wherein, the housing is configured to be paced between the first truck and the second truck when the lighting device is removably connected to the skateboard.

7. The lighting device of claim 1, wherein the housing is a rigid, separable casing.

8. The lighting device of claim 1, wherein the light source fastener is an adhesive.

9. The lighting device of claim 1, wherein the light source further comprises:
a connector cable configured to removably electrically connect the light source to the power source.

10. The lighting device of claim 1, wherein the light source comprises a plurality of light emitting diodes.

11. The lighting device of claim 1, wherein the power source is a lithium-polymer battery.

12. The lighting device of claim 1, further comprising:
a switch, controllable by a user, configured to activate the lighting device.

13. The lighting device of claim 1, further comprising:
a remote control, configured to communicate with the microcontroller, controllable by a user, and capable of altering the operational state of the lighting device.

14. The lighting device of claim 1, wherein the light source may emit a plurality of wavelengths of light.

15. The lighting device of claim 1, wherein the microcontroller may cause the light source to operate in one of: a twinkling pattern: a flashing pattern; and a strobe pattern.

16. The lighting device of claim 1, wherein the microcontroller may cause the light source to operate in a variable pattern.

17. The lighting device of claim 1, wherein the microcontroller may vary the brightness of the light source.

18. The lighting device of claim 1, wherein the light source emits diffuse light.

19. The lighting device of claim 1, wherein the light source emits at least one focused ray of light.

20. The lighting device of claim 1, further comprising:
at least one additional light source;
wherein each of the at least one additional light source is electrically connected to the power source.
